(19) United States
(12) Patent Application Publication
(10) Pub. No.: US 2018/0050366 A1
(43) Pub. Date: Feb. 22, 2018

(54) SYSTEM AND METHOD FOR PREVENTING OVERFLOW OF ADHESIVE

(71) Applicant: HON HAI PRECISION INDUSTRY CO., LTD., New Taipei (TW)

(72) Inventor: HSI-CHANG WU, New Taipei (TW)

(21) Appl. No.: 15/681,412

(22) Filed: Aug. 20, 2017

(30) Foreign Application Priority Data
Aug. 22, 2016 (TW) 105126788

(51) Int. Cl. B05C 11/10; B05C 11/02; B29C 59/04; B32B 37/00; B32B 37/12; C09J 5/06; C08L 67/03

(52) U.S. Cl. CPC B05C 11/1018; B05C 11/025; B29C 59/046; B32B 37/0053; C09J 2205/30; C09J 5/06; C08L 67/03; B32B 2367/00; B32B 37/1284

(57) ABSTRACT

A system for preventing overflow of adhesive applied to a PET rolling film includes a drive unit, a detection unit, and a processing unit. The detection unit detects whether UV adhesive spread on a PET film flows out to limit lines on the PET film. The detection unit generates trigger signal upon detecting that the UV adhesive on the PET film flows to any of the limit lines, and then transmits the trigger signal to the processing unit. The processing unit controls the drive unit to accelerate a rotational speed of a guide roller for the PET film upon receiving the trigger signal from the detection unit, so as to accelerate a moving speed of the PET film.

### CROSS REFERENCE TO RELATED APPLICATION

This application claims priority to Taiwan Patent Application No. 105126788, filed Aug. 22, 2016, the disclosure of which is incorporated herein by reference in its entirety.

### FIELD

The present disclosure relates to production of materials control, and more particularly to a system and method for preventing overflow of adhesive, which is beneficial to production of brightness enhancement films.

### BACKGROUND

A conventional process for production of brightness enhancement films is a continuous roll-to-roll process. The continuous roll-to-roll process comprises embossing and curing a polyethylene terephthalate (PET) film with ultraviolet curable adhesive (UV adhesive), thus producing a brightness enhancement film having microstructures. However, a UV adhesive overflow on the PET film is difficult to prevent.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of a system for preventing overflow of adhesive.

FIG. 2 is a schematic perspective view of a roll-to-roll laminator.

FIG. 3 is a schematic top view of a PET film.

FIG. 4 is a flow diagram of a method for preventing overflow of adhesive.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein can be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

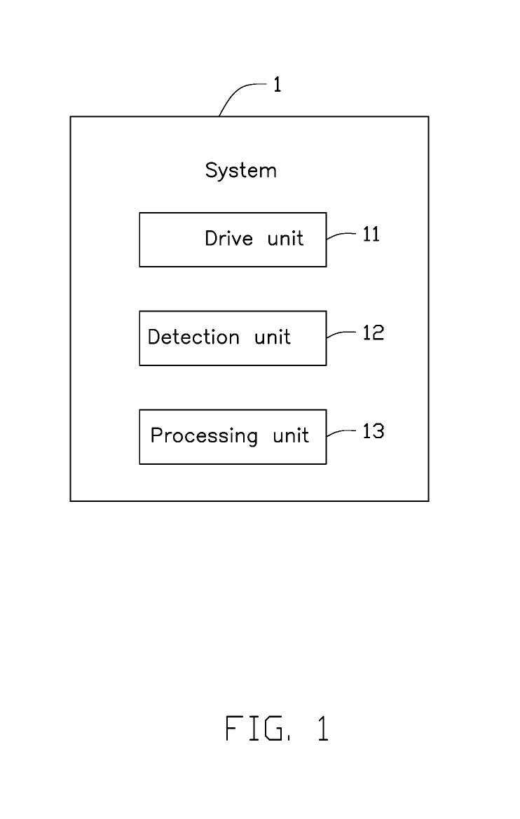

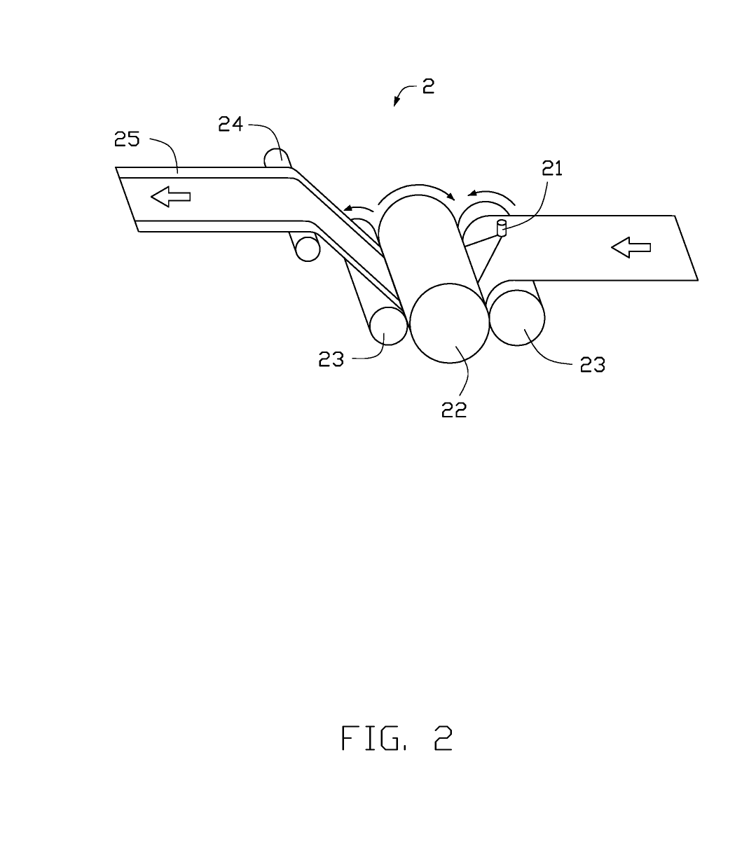

With reference to FIG. 1, an exemplary embodiment of a system 1 for preventing overflow of adhesive is applied to a roll-to-roll laminator 2. With reference to FIG. 2, the roll-to-roll laminator 2 includes a gumming device 21, a center roller 22, two side rollers 23, and a guide roller 24. A PET film 25 is disposed between the center roller 22 and the side rollers 23. The gumming device 21 can apply UV adhesive to the PET film 25. A rotational direction of the center roller 22 is opposite to a rotational direction of the side rollers 23. The center roller 22 and the side rollers 23 are rotated to spread UV adhesive on the PET film 25. The guide roller 24 can rotate to guide the movements of the PET film 25. The roll-to-roll laminator 2 further includes a UV lamp (not shown) for curing the UV adhesive on the PET film 25.

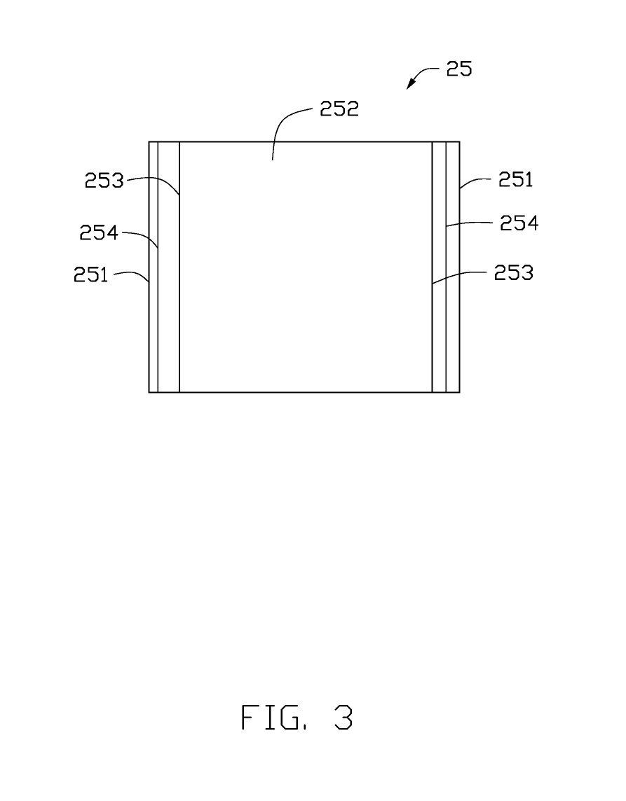

With reference to FIG. 3, the PET film 25 has two opposite sides 251, and a surface with two inner limit lines 253 and two outer limit lines 254. The inner limit lines 253 and the outer limit lines 254 are parallel to the sides 251. Each outer limit line 254 is disposed between one of the sides 251 and one of the inner limit lines 253. A predetermined applying zone 252 is defined between the inner limit lines 253. The inner limit lines 253 and the outer limit lines 254 are used to determine an extent to which the UV adhesive is spread in relation to the applying zone 252.

With reference to FIG. 1, the system 1 for preventing overflow of adhesive includes a drive unit 11, a detection unit 12, and a processing unit 13. The drive unit 11 can drive the guide roller 24 to rotate. The detection unit 12 is configured to detect whether the UV adhesive on the PET film 25 flows to the inner limit lines 253 and the outer limit lines 254. The detection unit 12 generates an auxiliary trigger signal upon detecting that the UV adhesive on the PET film 25 flows to either of the two inner limit lines 253, and then transmits the auxiliary trigger signal to the processing unit 13. The processing unit 13 triggers an alarm upon receiving the auxiliary trigger signal from the detection unit 12. The alarm may be a flash alarm or a buzzer alarm. The detection unit 12 generates a main trigger signal upon detecting that the UV adhesive on the PET film 25 flows to either of the two outer limit lines 254, and then transmits the main trigger signal to the processing unit 13. The processing unit 13 controls the drive unit 11 to accelerate a rotational speed of the guide roller 24 upon receiving the main trigger signal from the detection unit 12, so as to accelerate a moving speed of the PET film 25. The accelerating movement of the PET film 25 prevents the overflow of the UV adhesive on the PET film 25. The processing unit 13 also controls the gumming device 21 to reduce an amount of the UV adhesive applied to the PET film 25 upon receiving the main trigger signal from the detection unit 12. The reduction in the amount of the UV adhesive applied to the PET film 25 prevents the overflow of the UV adhesive on the PET film 25.

In the present exemplary embodiment, the detection unit 12 includes two inner laser light sensors and two outer laser light sensors. One inner laser light sensor and one outer laser light sensor are mounted on one side 251 of the PET film 25, and the other inner laser light sensor and the other outer laser light sensor are mounted on the other side 251 of the PET film 25. The two inner laser light sensors are configured to respectively detect whether the UV adhesive on the PET film 25 flows to the two inner limit lines 253, and the two outer laser light sensor are configured to respectively detect whether the UV adhesive on the PET film 25 flows to the two outer limit lines 254. Either of the inner laser light sensors can generate the auxiliary trigger signal upon detecting that the UV adhesive on the PET film 25 flows to the inner limit line 253, and then transmit the auxiliary trigger signal to the processing unit 13. Either of the outer laser light sensors can generate the main trigger signal upon detecting that the UV adhesive on the PET film 25 flows to the outer limit line 254, and then transmit the main trigger signal to the processing unit 13.

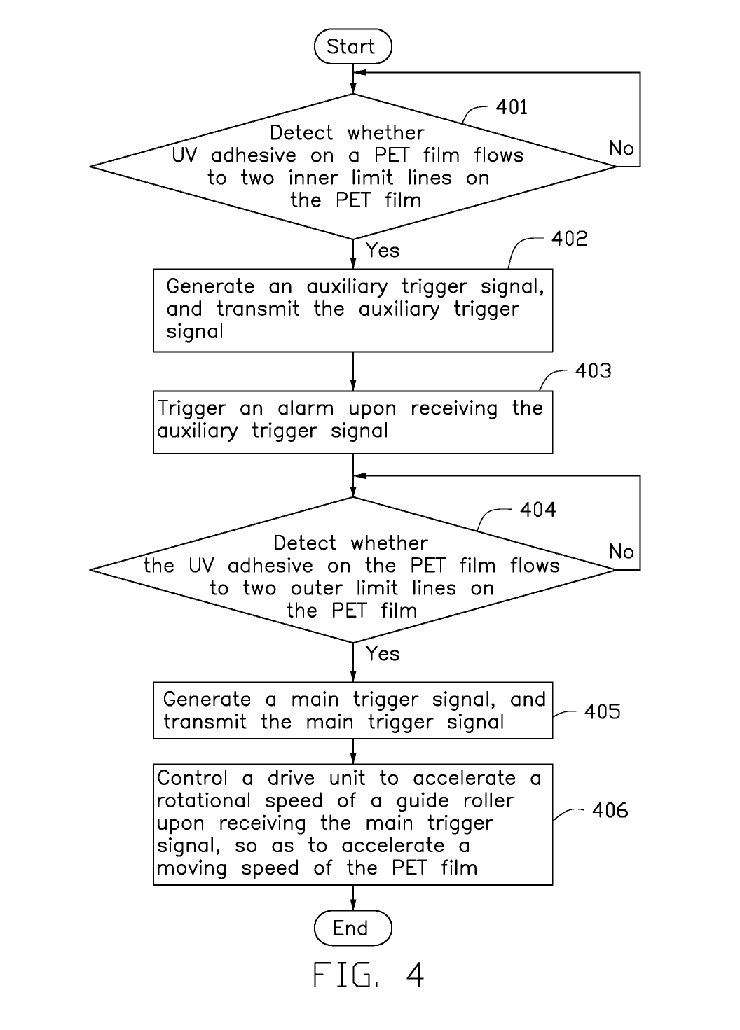

With reference to FIG. 4, an exemplary embodiment of a method for preventing overflow of adhesive is illustrated.

In step 401, the detection unit 12 detects whether the UV adhesive on the PET film 25 flows to the inner limit lines 253. If yes, step 402 is executed, otherwise the step 401 is executed.

In step 402, the detection unit 12 generates the auxiliary trigger signal, and transmits the auxiliary trigger signal to the processing unit 13.

In step 403, the processing unit 13 triggers an alarm upon receiving the auxiliary trigger signal from the detection unit 12.

In step 404, the detection unit 12 detects whether the UV adhesive on the PET film 25 flows to the outer limit lines 254. If yes, step 405 is executed, otherwise the step 404 is executed.

In step 405, the detection unit 12 generates the main trigger signal, and transmits the main trigger signal to the processing unit 13.

In step 406, the processing unit 13 controls the drive unit 11 to accelerate the rotational speed of the guide roller 24 upon receiving the main trigger signal from the detection unit 12, so as to accelerate the moving speed of the PET film 25. The processing unit 13 also controls the gumming device 21 to reduce the amount of the UV adhesive applied to the PET film 25 upon receiving the main trigger signal from the detection unit 12.

The exemplary embodiments shown and described above are only examples. Many details are often found in the art such as the other features of a system and method for preventing overflow of adhesive. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the exemplary embodiments described above may be modified within the scope of the claims.

What is claimed is:

1. A system for preventing overflow of adhesive applied to a polyethylene terephthalate (PET) rolling film comprising: a drive unit, a detection unit, and a processing unit;
wherein the detection unit detects whether ultraviolet curable adhesive (UV adhesive) on a PET film flows to two outer limit lines on the PET film, and the detection unit generates a main trigger signal upon detecting that the UV adhesive on the PET film flows to either of the two outer limit lines, and then transmits the main trigger signal to the processing unit; and
wherein the processing unit controls the drive unit to accelerate a rotational speed of a guide roller upon receiving the main trigger signal from the detection unit, so as to accelerate a moving speed of the PET film.

2. The system of claim 1, wherein the processing unit controls a gumming device to reduce an amount of the UV adhesive applied to the PET film upon receiving the main trigger signal from the detection unit.

3. The system of claim 1, wherein the detection unit detects whether UV adhesive on the PET film flows to two inner limit lines on the PET film, and the detection unit generates an auxiliary trigger signal upon detecting that the UV adhesive on the PET film flows to either of the two inner limit lines, and then transmits the auxiliary trigger signal to the processing unit.

4. The system of claim 2, wherein the detection unit detects whether UV adhesive on the PET film flows to two inner limit lines on the PET film, and the detection unit generates an auxiliary trigger signal upon detecting that the UV adhesive on the PET film flows to either of the two inner limit lines, and then transmits the auxiliary trigger signal to the processing unit.

5. The system of claim 3, wherein the processing unit triggers an alarm upon receiving the auxiliary trigger signal from the detection unit.

6. The system of claim 4, wherein the processing unit triggers an alarm upon receiving the auxiliary trigger signal from the detection unit.

7. The system of claim 1, wherein the detection unit comprises a plurality of laser light sensors.

8. The system of claim 2, wherein the detection unit comprises a plurality of laser light sensors.

9. The system of claim 3, wherein the detection unit comprises a plurality of laser light sensors.

10. The system of claim 4, wherein the detection unit comprises a plurality of laser light sensors.

11. The system of claim 5, wherein the detection unit comprises a plurality of laser light sensors.

12. The system of claim 6, wherein the detection unit comprises a plurality of laser light sensors.

13. A method for preventing overflow of adhesive, the method comprising:
detecting, by a detection unit, whether ultraviolet curable adhesive (UV adhesive) on a polyethylene terephthalate (PET) film flows to two outer limit lines on the PET film;
generating, by the detection unit, a main trigger signal upon detecting that the UV adhesive on the PET film flows to either of the two outer limit lines, and then transmitting the main trigger signal to a processing unit; and
controlling, by the processing unit, a drive unit to accelerate a rotational speed of a guide roller upon receiving the main trigger signal, so as to accelerate a moving speed of the PET film.

14. The method of claim 13, further comprising:
controlling, by the processing unit, a gumming device to reduce an amount of the UV adhesive applied to the PET film upon receiving the main trigger signal.

15. The method of claim 13, further comprising:
detecting, by the detection unit, whether the UV adhesive on the PET film flows to two inner limit lines on the PET film;
generating, by the detection unit, an auxiliary trigger signal upon detecting that the UV adhesive on the PET film flows to either of the two inner limit lines, and then transmitting the auxiliary trigger signal; and
triggering, by the processing unit, an alarm upon receiving the auxiliary trigger signal.

16. The method of claim 14, further comprising:
detecting, by the detection unit, whether the UV adhesive on the PET film flows to two inner limit lines on the PET film;
generating, by the detection unit, an auxiliary trigger signal upon detecting that the UV adhesive on the PET film flows to either of the two inner limit lines, and then transmitting the auxiliary trigger signal; and
triggering, by the processing unit, an alarm upon receiving the auxiliary trigger signal.

17. The method of claim 13, wherein the detection unit comprises a plurality of laser light sensors.

18. The method of claim 14, wherein the detection unit comprises a plurality of laser light sensors.

19. The method of claim 15, wherein the detection unit comprises a plurality of laser light sensors.

20. The method of claim 16, wherein the detection unit comprises a plurality of laser light sensors.
